(19) United States
(12) Patent Application Publication
(10) Pub. No.: US 2023/0063365 A1
(43) Pub. Date: Mar. 2, 2023

(54) SYSTEM AND METHOD FOR EXTRACTION OF LOOSE TOOTH

(71) Applicant: Tala Emmanuelle ORETSKY, Miami, FL (US)

(72) Inventor: Tala Emmanuelle ORETSKY, Miami, FL (US)

(21) Appl. No.: 17/513,277

(22) Filed: Oct. 28, 2021

Related U.S. Application Data
(60) Provisional application No. 63/236,286, filed on Aug. 24, 2021.

(51) Int. Cl. A61C 3/14

(52) U.S. Cl. CPC A61C 3/14; A61C 2203/00

(57) ABSTRACT

An intraoral device for wiggling a loose tooth for easier extraction includes a distal portion configured to move in a back-and forth and/or twisting motion and including tooth contact portions configured to contact at least opposing sides of a loose tooth, a proximal portion including a drive for driving the distal portion, a form factor having aesthetics for engaging a child's mind, and a counter or timer configured to sense the number of cycles or duration of the cycles required to cause the tooth to shed.

### FIELD OF THE INVENTION

The present invention relates generally to systems and methods of extraction of loose teeth.

### BACKGROUND

The shedding of baby teeth is generally viewed as a positive experience for children, as it is considered a sign of growing up in many cultures. Such positivity is often reinforced in a tangible way, for example, by receipt of monetary remuneration in return for transferal of the lost tooth to a magical being, known in some cultures as the Tooth Fairy.

Some baby teeth can remain loose for a period of days or even weeks, and so it is common for children to wiggle loose teeth in an effort to hasten shedding of the tooth. Children in some cases will count the number of wiggles required to cause a loose tooth to come out, or even have contests with friends who have loose teeth of their own, in which they compare the number of wiggles or amount of time required for their respective loose tooth to shed. Therefore, systems and methods for assisting in the wiggling of loose teeth in an entertaining, harmless manner may help ensure and further enhance the positive experiences associated with shedding baby teeth.

### SUMMARY

An intraoral device for wiggling a loose tooth for easier extraction includes a distal portion configured to move in a back-and forth and/or twisting motion and including tooth contact portions configured to contact at least opposing sides of a loose tooth, a proximal portion including a drive for driving the distal portion, a form factor having aesthetics for engaging a child's mind, and a counter or timer configured to sense the number of cycles or duration of the cycles required to cause the tooth to shed.

In an embodiment, the device includes a motor configured to drive the tooth contact portions, the form factor comprises a form of a character, and the device further includes a display for displaying the number of cycles or duration of the cycles required to cause the tooth to shed.

A method for extracting a loose tooth includes providing the intraoral, engaging the tooth contact portions with a loose tooth, and activating the intraoral device to cause the tooth contact portions to move relative to the loose tooth.

### BRIEF DESCRIPTION OF THE DRAWINGS

FIG. 1 illustrates a side view of a tooth extraction device according to an embodiment.

FIGS. 2A-2D illustrate a cut-away view of the housing of the FIG. 1 device during four stages of operation.

FIG. 3 illustrates a side view of a tooth extraction device according to a second embodiment.

FIG. 4 illustrates a schematic view of an electronic counter of a tooth extraction device.

### DETAILED DESCRIPTION

Set forth below with reference to the accompanying drawings is a detailed description of embodiments of a system and method which assists in and/or automates the back-and-forth or twisting movement of a loose tooth.

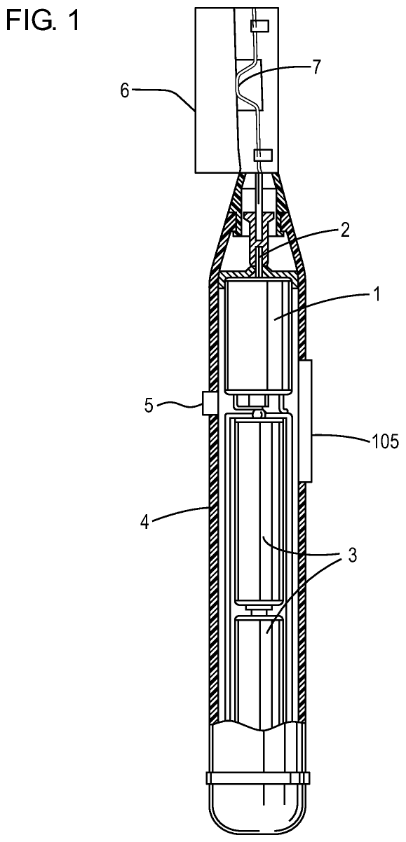

An embodiment of the device includes a battery-operated motor 1 which rotates a shaft 2, as shown in FIG. 1. In the embodiment, the motor 1 and batteries 3 are provided in a handle 4 that approximates an electric toothbrush handle. Alternatively, the motor and battery or batteries may be provided in a down-sized arrangement such that the entire device can fit in the user's mouth. The batteries 3 can be replaceable or rechargeable. The motor 1 can be actuated by, for example, a button 5 on the handle 4 or, in embodiments without a handle, by a pressure sensitive switch actuatable by the user's teeth. In some embodiments, the button or switch is associated with a timer which will cause the device to actuate for a predetermined number of cycles or timeframe.

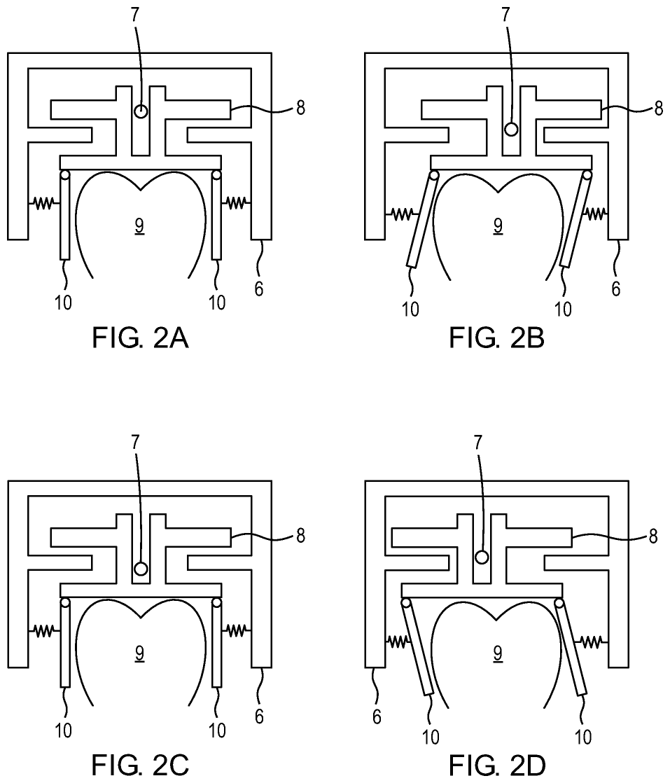

In the embodiment, a housing 6 of the device is configured to be placed over a loose tooth 9, and, as illustrated in FIGS. 2A-2D, an offset portion 7 of the shaft 2 rotates within the housing 6 to cause a slider 8 to slide back and forth over the tooth 9. The specific mechanism for causing the sliding movement of the slider 8 is only exemplary and other known mechanisms for creating a back-and-forth and/or twisting motion may also be implemented in the device. Furthermore, one or more of the housing 6 and the slider 8 can be of multi-piece construction, for example, to facilitate assembly of the housing 6 with the slider 8. Additionally, structure such as a tongue and groove arrangement can be provided to ensure that the slider 8 can only move relative to the housing 6 along a single axis. The portion of the device which enters the mouth, which may be, for example, just the housing 6 and the components therein, or the entire device, can be made of or coated with a material that is one of more of anti-microbial, a soft but sticky type of material such as a rubber, a material that resembles gauze texture, and/or a combination of materials that provide different types of texture to provide varying levels of grip and/or friction.

The sliding movement of the slider 8 causes inwardly-biased biased tooth engagement structures (in the embodiment, rockers 10) to move side-to side, as illustrated in FIGS. 2A-2D. In the embodiment, the rockers 10 are flat-plate shaped and swingably connected on one side thereof to opposite ends of the slider 8. This configuration causes the rockers 10 push the front and back sides of the tooth 9 in an alternating matter, to impart a rocking motion on the tooth 9, as the slider 8 slides back and forth over the tooth 9. Additionally, other tooth-engagement structures can be provided. For example, instead of rockers, resilient elastomeric curved structures configured to grasp each side of the tooth may be provided on the slider. The tooth engagement structures may also instead be manually or electronically adjustable clamping structures. Alternatively, a string which loops around the tooth may be provided as the tooth engagement structure. Furthermore, the slider may be configured to move along an arc within the housing so that a twisting movement is imparted on the tooth.

In embodiments, the tooth engagement structure may be constructed or decorated to appear as or be provided with, for example, a decoration such as a human hand, an animal's claw, the wand of a tooth fairy, or any such whimsical element that a child may associate with action to assist in shedding of a baby tooth. The remainder of the device may be decorated to appear, for example, as the character wielding the hand, claw, wand, etc. The device may further include an enclosure configured to hold one or more of the teeth that have been shed. In embodiments with the handle, this enclosure may be provided in the handle.

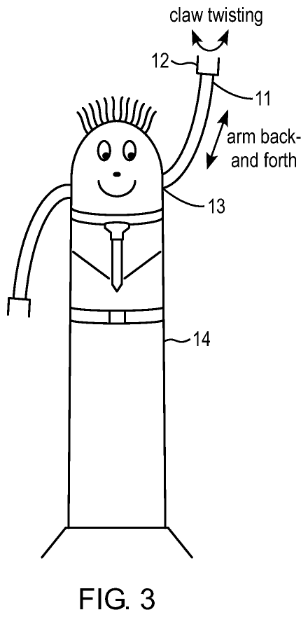

In embodiments, a back and forth motion may be provided by swinging an arm structure a small distance about an about an axis. For example, in the embodiment illustrated in FIG. 3, the arm 11 of the device can configured to pivot slightly about the shoulder 13 of the body 14, or to move back-and-forth relative to the shoulder 13. Furthermore, the free end of the arm 11 is attached to the tooth, for example, by a claw 12 that can be fixed or spring loaded to put pressure on and grip the tooth. When the claw 12 is engaged with a loose tooth, any of a slight pivoting and/or back-and-forth movement of the arm 11 will urge the tooth to move back-and-forth. This back-and-forth movement simulates the back-and-forth movement children are known to manually impart to their loose teeth. In an embodiment in which the arm 11 moves back and forth, the back and forth movement can be provided, for example, by a mechanism similar to the mechanism of the FIG. 2 embodiment which causes the slider to move back and forth. Furthermore, in an embodiment in which the arm 11 pivots back and forth, this pivoting movement can be provided, for example, by attaching the end of the arm at the shoulder to a servomotor programmed to rotate back and forth through relatively small angular displacements.

Embodiments of the device may also impart a slight twisting motion on the tooth, with the twisting direction being about the central axis of the tooth. In the FIG. 3 embodiment, in addition to, or as an alternative to, the movement of the arm 11 relative to the body 14, the claw 12 itself can move in a twisting movement relative to the arm 11. This twisting movement simulates the twisting movement children are known to manually impart to their loose teeth. The twisting movement can be furnished to the claw 12 by, for example, attaching the claw 12 to a servomotor programmed to rotate back and forth through relatively small angular displacements. In additional embodiments, each type of movement can be individually activated or deactivated by a separate on/off switch, and/or the speed and/or distance of any or all of the movements can be varied by additional user controls. Furthermore, the device can take the form of a character such as, in the FIG. 3 embodiment, Albert Einstein, with the movable arm 11 of the device corresponding to one of the character's arms.

Further embodiments of the device can impart, instead of or in addition to a relatively gentle cyclical movement to the tooth, a more forceful movement corresponding to a yanking of the tooth. Such a more forceful movement can be driven by, for example, a hydraulic cylinder arrangement disposed within the housing of the device. The tooth engagement structure can be, for example, a string looped around the tooth and connected to, for example, an arm attached to the drive. Embodiments of the device according to the foregoing can simulate, for example, the time-tested remedy of tying one end of a string around the tooth, the other end of the string around a door handle, and slamming the door closed. Embodiments of the device can also be adapted as an instrument provided for use by a dentist.

The device may further include an electronic or mechanical counter that senses the number of cycles the tooth is moved back and forth, and/or a timer. The counter and/or the timer may be resettable, and the device may further include a display which displays the number of wiggles or duration of wiggling. The counter, timer, and display may be provided, for example, on the handle. The device may further include sound/and or light effects that may be, for example, changeable and programmable to, for example, change with the pressure, time, and/or a pre-selected theme. The device may further include a functional light source that shines a light on the tooth being wiggled as well as a camera capable of recording in the mouth.

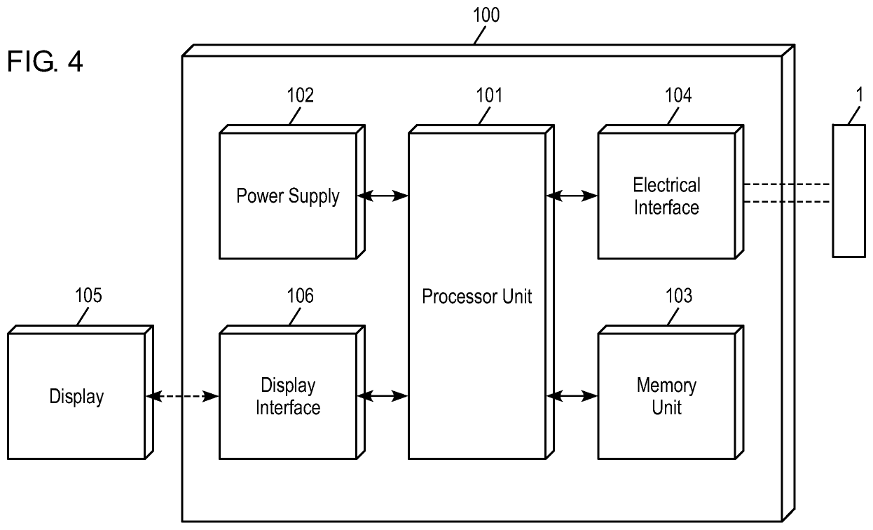

FIG. 4 illustrates an example of an electrical counter 100 as the timer. The electrical counter 100 includes a processor unit 101 connected to a power supply 102, a memory unit 103, an electrical interface 104 connected to the motor 1, a display 105, and a display interface 106. The processor unit 101 may be a single processor, a plurality of processors, or combinations thereof. Processor devices may have one or more processor “cores.” The power supply 102 may be a replaceable or rechargeable battery. The memory unit 103 is a non-transitory computer-readable storage media, such as one or more memory semiconductors (e.g., DRAMs, etc). The processor unit 101 is configured to receive electrical signals from the motor 1 via the electrical interface 104, and convert those signals into data indicating a number of cycles the motor has rotated or the duration the motor has run. This data is output to the display 105 via the display interface 106.

The device can further include a wireless communication device such as a Bluetooth or WiFi transceiver which can send data such as the duration, number of wiggles, and or photo or video from within the mouth to, for example a software application running on a mobile device. The application may be configured to link the duration and/or number of wiggles to the particular tooth that was wiggled/shed, and may also contain pictures of the tooth in mouth and out of mouth and all dates for each tooth.

The detailed description above describes embodiments of a system and method for extraction of a loose tooth. The invention is not limited, however, to the precise embodiments and variations described. Various changes, modifications and equivalents can be effected by one skilled in the art without departing from the spirit and scope of the invention as defined in the accompanying claims. It is expressly intended that all such changes, modifications and equivalents which fall within the scope of the claims are embraced by the claims.

What is claimed is:

1. An intraoral device for wiggling a loose tooth for easier extraction, comprising:
a distal portion configured to move in a back-and forth and/or twisting motion and including tooth contact portions configured to contact at least opposing sides of a loose tooth,
a proximal portion including a drive for driving the distal portion,
a form factor having aesthetics for engaging a child's mind, and
a counter or timer configured to sense the number of cycles or duration of the cycles required to cause the tooth to shed.

2. The intraoral device of claim 1, further comprising a motor configured to drive the tooth contact portions.

3. The intraoral device of claim 1, wherein the form factor comprises a form of a character.

4. The intraoral device of claim 1, further comprising a display for displaying the number of cycles or duration of the cycles required to cause the tooth to shed.

5. A method for extracting a loose tooth, comprising:
providing an intraoral device according to claim 1;
engaging the tooth contact portions with a loose tooth; and
activating the intraoral device to cause the tooth contact portions to move relative to the loose tooth.
